(19) United States
(12) Patent Application Publication
(10) Pub. No.: US 2018/0005256 A1
(43) Pub. Date: Jan. 4, 2018

(54) SHOPPING INCENTIVE APPLICATION

(71) Applicants: Deann Marie Stowers, Racine, MN (US); Dana Stowers, Racine, MN (US); Brian Hovey, Racine, MN (US)

(72) Inventors: Deann Marie Stowers, Racine, MN (US); Dana Stowers, Racine, MN (US); Brian Hovey, Racine, MN (US)

(21) Appl. No.: 15/598,870

(22) Filed: May 18, 2017

Related U.S. Application Data
(63) Continuation-in-part of application No. 14/521,632, filed on Oct. 23, 2014, now abandoned.

(51) Int. Cl. G06Q 30/02; A63F 9/24

(52) U.S. Cl. CPC G06Q 30/0212; G06Q 30/0237; A63F 2009/2485

(57) ABSTRACT

A shopping incentive and discount system and method for consumers including: a processing system, where the processing system includes a database, memory and a processor; software residing of the memory of the processing system, wherein the software enables functions related to the shopping incentive and discount system; and a portable computing device, where a user utilizes the portable computing device to access the shopping incentive and discount system. The functions available through the shopping incentive and discount system may include coupon retrieval, prize contests, rewards system, winning number generation and interactive features. The shopping incentive and discount system preferably includes downloadable interactive software for consumer users.

### CROSS REFERENCE TO OTHER APPLICATIONS

This application is a continuation in part to U.S. patent application Ser. No. 14/521,632 filed on Oct. 23, 2014.

### BACKGROUND OF THE INVENTION

### Field of Invention

The present invention relates to a mobile application to be used to encourage and motivate shoppers through a localized incentive program.

### Description of Related Art

Presently many forms of shopping incentives and marketing are available through various digital means through the use of the Internet and Smartphones. Many businesses market through online shopping discount systems such as Groupon® or other discount or shopping incentive programs. Through these programs businesses can offer discounts to customers to encourage and increase sales volume and notoriety. Further in addition to the web-based shopping or consumer marketing systems some of these systems have been integrated into Smartphones for use with applications used directly on a Smartphone. Many times these sales incentives are again linked to an Internet web site or database that stores the customer's information and interacts with the merchant and consumer to achieve optimal shopping discounts and incentives. To further encourage this type of marketing and shopping incentives, it would be advantageous to develop even more creative applications to use in conjunction with Smartphones.

### SUMMARY OF THE INVENTION

The present invention relates to a shopping incentive and discount system for consumers comprising: a processing system, where the processing system includes a database, memory and a processor; software residing of the memory of the processing system, wherein the software enables functions related to the shopping incentive and discount system; and a portable computing device, where a user utilizes the portable computing device to access the shopping incentive and discount system. The functions available through the shopping incentive and discount system may include coupon retrieval, prize contests, rewards system, winning number generation and interactive features. The shopping incentive and discount system preferably includes downloadable interactive software for consumer users.

The present invention also relates to a method of shopping incentive and discount offerings comprising the steps of: implementing an interactive system in a shopping facility, where the interactive system includes a processor, memory, database and software; allowing consumer access to the interactive system through a portable electronic device; creating at least the following functions through the interactive system a coupon retrieval, prize contests, a rewards system and a wining number generator; and periodically making the interactive system available in the shopping facility. The step of allowing consumer access includes enabling consumer accounts stored on the database and allowing consumers to download software for use on the portable electronic device.

### BRIEF DESCRIPTION OF DRAWINGS

FIG. 1 depicts a mobile application shopping incentive system in accordance with the present invention.

### DETAILED DESCRIPTION

The present invention relates to a shopping or customer incentive system that is integrated within a Smartphone application used by customers. This particular system increases revenues for the merchant by encouraging consumers to visit and shop at a particular merchant location. The system in accordance with the present invention includes a mobile application installed on a user's Smartphone. This application is active and used within the merchant's facility to generate coupons that are active during a particular time period preset by the system. Shoppers or consumers are able to access these discounts and coupons once entering the zone with a merchant's shop where a shopping incentive zone is set up for use. The present invention includes software program that generates winning game numbers for a particular day and coupons for particular merchandise. The mobile application is downloaded by the consumer who may automatically sign into the merchant's system once entering the store location. Once entering the store location ongoing a series of games are active that allow or enable consumers to win prizes, collect coupons and receive special rewards through a rewards system. Further the system may include a loyalty reward system where each consumer's shopping activity is tracked and instant rewards are available for certain levels of purchases by an individual consumer. Although preferably used in a consumer retail shop, this particular invention may also be implemented in bars, restaurants, hotels or motels as other end users of the coupon and overall shopping incentive system of the present invention.

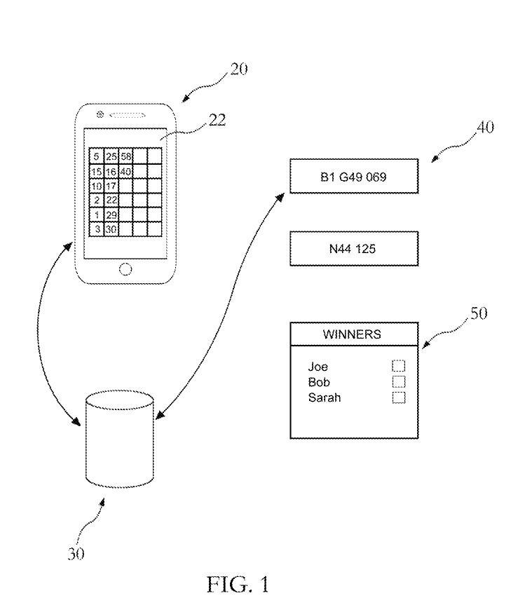

In reference to FIG. 1, the overall system according to the present invention is depicted. A user's Smartphone 20 is displayed with a Screen 22. Software related to the mobile app may be downloaded onto the Smartphone 20 a user may then interact with a System 30. This interaction includes the receipt of Winning Numbers 40 as depicted in FIG. 1. These winning numbers 40 are generated within the System 30, which includes a processor, memory and a database. The System 30 also stores software that operates the mobile application interaction with the merchant's System 30. Users are able to retrieve pre-generated winning numbers on their Smartphone 20 and further may be provided with coupons and other shopping incentives through the use of the Smartphone app installed on Smartphone 20. These incentives and other shopping-related activities are displayed on Screen 22 of the Smartphone 20. Further a Display 50 may be provided in a merchant's store that displays winners of particular items on particular days. The incentives as stated may be in the form of free prizes, special discounts, and coupons available for use in the merchant's facility.

The System 30 includes memory that stores consumer purchasing activity and tracks rewards associated with each user of the shopping incentive system according to the present invention. This system may also be implemented through a tablet for use with customers who may shop with a tablet as opposed to a smartphone. The system is completely interactive for the consumer and provides a dynamic marketing system for the merchant. The instant invention has been shown and described in what it considers to be the most practical and preferred embodiments. It is recognized, however, that departures may be made there from within the scope of the invention and that obvious modifications will occur to a person skilled in the art.

What is claimed is:

1. A shopping incentive and discount system for consumers comprising:
a. a processing system, where the processing system includes a database, memory and a processor;
b. software residing of the memory of the processing system, wherein the software enables functions related to the shopping incentive and discount system; and
c. a portable computing device, where a user utilizes the portable computing device to access the shopping incentive and discount system.

2. The shopping incentive and discount system according to claim 1, where the functions include coupon retrieval, prize contests, rewards system, winning number generation and interactive features.

3. The shopping incentive and discount system according to claim 1, further including downloadable interactive software for consumer users.

4. A method of shopping incentive and discount offerings comprising the steps of:
a. implementing an interactive system in a shopping facility, where the interactive system includes a processor, memory, database and software;
b. allowing consumer access to the interactive system through a portable electronic device;
c. creating at least the following functions through the interactive system a coupon retrieval, prize contests, a rewards system and a wining number generator; and
d. periodically making the interactive system available in the shopping facility.

5. The method of shopping incentive and discount offerings according to claim 4, wherein the step of allowing consumer access includes enabling consumer accounts stored on the database and allowing consumers to download software for use on the portable electronic device.

6. The method of shopping incentive and discount offerings according to claim 4, wherein the portable electronic device includes at least one of a smartphone or a tablet.

7. The method of shopping incentive and discount offerings according to claim 4, where the shopping facility includes at least one of a retail shop, a bar, a restaurant, a hotel or a grocery store.
